(19) United States
(12) Patent Application Publication
(10) Pub. No.: US 2002/0056371 A1
(43) Pub. Date: May 16, 2002

(54) Membrane system and method for separation of gases

(75) Inventor: Warren Hayes, Redondo Beach, CA (US)

Correspondence Address: Douglas R. Hanscom, JONES, TULLAR & COOPER, P.C., Eads Station, P.O. Box 2266, Arlington, VA, 22202, US

(73) Assignee: HAWKEYE ENTERPRISES, LLC

(21) Appl. No.: 09/963,434

(22) Filed: Sep. 27, 2001

Related U.S. Application Data
(60) Provisional application No. 60/235,728, filed on Sep. 27, 2000.

(51) Int. Cl. B01D 53/22

(52) U.S. Cl. 96/11

(57) ABSTRACT

A novel membrane filtration system for separating gases of closely spaced molecular sizes incorporates a uniform, pore free, ultrathin membrane of a rubbery polymer which functions to transport different gases at different rates by sorption effects. The membrane is formed on a microporous substrate without convective pores by preventing incipient polymerization before rapid curing in a deposition process. Employing porous but thin structural supports for the membrane/substrate layers, cells, modules and systems can be arranged for cost effective improvement of the thermal quality of nitrogen-contaminated methane in natural gas.

### REFERENCE TO PRIOR APPLICATION

This invention relies for priority on U.S. provisional application filed Sep. 27, 2000, Ser. No. 60/235,728 entitled MEMBRANE SYSTEM AND METHOD FOR SEPARATION OF GASES.

### FIELD OF THE INVENTION

This invention relates to the separation of mixed gases by means of differential permeation through polymeric membranes for industrial applications.

### BACKGROUND OF THE INVENTION

Membranes play an important role in the separation of gases. Separation processes include oxygen and nitrogen from air, CO₂ from subquality natural gas, CO₂ removal and sequestration from stack gases, Freon reclamation, VOCs from air and hydrocarbons from refinery hydrogen purge streams. Significantly lacking is the availability of a membrane for the effective separation of nitrogen from natural gas (essentially methane) that is subquality because of its nitrogen content. Nearly one quarter of the natural gas supply in the continental United States is of thermal subquality, either because of its nitrogen content or because of its mixed carbon dioxide/nitrogen content. Nitrogen separation is difficult because nitrogen and methane have almost identical molecular sizes. Conventional glassy polymer membranes separate gases based on differences in molecular size, and these materials cannot distinguish between nitrogen and methane. One of the most potentially useful membrane materials for separating this gas pair are ultrathin rubbery materials of the silicone class. This is because rubbery materials base their selectivity for gas separation on the absorption of the gases into the membrane. Methane is absorbed into rubbery membrane materials more than three times more effectively than nitrogen and even higher selectivity is attained at lower temperatures. There have been significant problems in the use of such rubbery membrane materials, however, because heretofore such materials could not be formed into thin films that were nonporous. These early silicone films were subject to the inclusion of micropores, which established undesirable convective shunt paths for the gases to flow through the films, thus eliminating the exclusively permeation-effected flow of gases through the membrane material and consequently the opportunity to separate gases based on differential permeation rates.

There are two general classes of polymeric membrane materials: rubbery silicone based materials and glassy polymer materials such as cellulose acetates and polysulfones. Silicone based membrane materials have considerably higher gaseous permeation rates and are preferable for this reason. The second advantage of the rubbery or silicone membranes over the glassy polymer membranes is their ability to separate molecules of similar size such as nitrogen and methane. Glassy polymer membrane materials are molecular size selective and therefore cannot play an effective role in processes such as the separation of excessive nitrogen content from methane in subquality natural gas. The availability of such processes is a very important economic factor relative to petroleum products as there are large gas reserves that are not being exploited because of their excessive nitrogen content.

For a membrane filtration process for a natural gas mixture which is thermally deficient to be cost efficient for practical use, it must be superior to existing techniques, such as cryogenic fractionation, pressure swing adsorption, and various absorption techniques, none of which have found widespread commercial acceptance in this field. All of these alternative separation processes are capital intensive, and the cost of separating nitrogen from natural gas by any one of these processes has been considered by the industry to be excessive.

Extensive efforts to provide very thin membranes of silicone (one of the rubbery materials) have not been able to achieve pore-free structures, and the existence of interconnected micropores which convect both methane and nitrogen defeats selectivity. Germane patents relative to the use of silicone membrane for gas separation are U.S. Pat. Nos. 5,085,776 and 5,669,958, which reveal that the tradeoff between gas selectivity and gas transport rates inherently limit cost effectiveness if conventional approaches are used.

Attempts have been made to develop a silicone membrane by casting a highly dilute solution of a silicone prepolymer upon a porous polysulfone substrate. Instead of collecting as a film on the surface of the substrate, however, the solution saturated the pores of the substrate. Thus when the solvent evaporated, the residual prepolymer molecules upon curing simply plugged the pores of the substrate, and did not form a uniform surface film of silicone. It was known from the glassy polymer membrane industry that one could densify the surface of a porous polysulfone material, to form “an asymmetric surface layer of polysulfone with pore density below 10%”. Thus polysulfone substrates were modified by the formation of such an asymmetric surface layer having greatly diminished pore density. When the dilute silicone prepolymer solution was cast upon this surface, it quickly filled the residual pores, but for the most part did indeed float on the poreless asymmetric polysulfone layer. Then, as the solvent evaporated, the residual silicone prepolymer molecules polymerized to form an ultrathin silicone film. This therefore was not a silicone membrane, but rather a silicone/polysulfone composite membrane with permeation characteristics reflective of the permeation properties of both materials. In passing through this composite membrane, a gas must first diffuses through the microvoid network of the asymmetric polysulfone layer, and then flow by sorption through the silicone layer. But since polysulfone is greatly less permeable than silicone, the inclusion of this barrier in the composite membrane greatly increases the impedance to gas permeation, as compared to the intrinsic impedance of a silicone film alone. Also, because polysulfone is a glassy polymer, it is unable to separate nitrogen and the asymmetric layer somewhat negates the selectivity of the silicone layer. Both selectivity and transport rates were diminished by this approach.

### SUMMARY OF THE INVENTION

Products and methods in accordance with the invention provide effective separation of gases having little difference in their molecular sizes by forming an ultrathin but nonporous rubbery membrane, as of silicone material, and supporting it with a microporous substrate as it is exposed to a pressurized gas mixture. Gas selectivity is thus determined essentially only by the permeation characteristics of the membrane, which is thin enough to provide rapid permeation rates, and therefore effective separation yields, while also being sufficiently robust to resist the energizing input pressure. Devices in accordance with the invention are arranged in cells, modules and other configurations, and may employ multiple parallel or cascaded membranes. Processes in accordance with the invention are based upon rapid mechanical layering concurrent with short term catalytic activation and rapid polymerization from a raw monomer state.

An important aspect of the invention is that a silicone film is deposited on a microporous material of sufficient pore density and sufficiently small pore size for support without flow blockage. The silicone or other film is an ultrathin rubber polymer permselective layer which is free of micropores and substantially uniform in thickness despite bridging across underlying micropores. The microporous support material might be a polymer, porous metal or porous ceramic, with a pore density of at least 20% to preferably 75% and above. A synthetic polymeric filter material is found to have superior properties in terms of pore size and uniformity. This composite structure responds adequately to applied moderate gas pressures if of small size, although it may also be supported by an underlying fine metallic mesh or other support layer if higher pressures or larger areas are to be used.

In accordance with the invention, a suitable precursor material, such as a silicone material, is selected which cures quickly when exposed to air, i.e. water vapor, and has sufficient viscosity to prevent the creation of linked microvoids (pores) in the cure process. The cure time is sufficiently rapid to assure that the polymer is set before incipient polymerization can occur. Before such incipient polymerization the film precursor material is advantageously sealed and refrigerated until the time of application. Deposition of the material on the substrate is virtually coincident with the exposure to catalyzing water vapor, and by adjusting viscosity the cure process can assure that surface forces on the curing precursor do not result in seepage of the material into the pores in the substrate.

Rubbery membranes, such as those made of silicone materials, are preferably used because of their high permeation rate combined with an ability to separate gases having similar molecular sizes. Thus, methane and other hydrocarbons can effectively be separated from nitrogen in natural gas whose nitrogen content level renders it of thermal subquality. By controlling the temperature, viscosity, and ambient humidity exposure of the silicone film precursor material in the film application process, films on the order of a micron or less in thickness, but having no micropores, can be reproducibly formed. In accordance with other aspects of the invention, cooled and sealed prepolymer is supplied, by means of roller action, to a microporous substrate having a pore size of approximately one micron. The silicone precursor, having a viscosity in the range of 500-5000 centipose, is applied by means of a roller action, with control of film thickness being obtained by the rate of roller traversal, and by varying the viscosity of the precursor via the solvent to silicone precursor mixture ratio. Rapid coating of the film on the substrate, and initiation of the cure cycle, are completed within a few seconds such that incipient polymerization is blocked and the transition to polymerization is essentially a step function. By using a refrigerated prepolymer, and effecting application and gelling within five minutes, the structure of the silicone film is fixed and premature polymerization is avoided. Any free micro-volumes created in the polymerization process exist as isolated, small microvoids, without creating an open pore network. Also, by further controlling the ratio of solvents to solids in the prepolymer, the film can gel and completion of the first phase of curing can be effected in less than five minutes.

Products in accordance with the invention employ the microporous substrate as support for the thin film membrane, but in addition may use a supplementary support, such as a stainless steel mesh. Alternatively, the support may comprise microporous ceramics, porous sintered powder metal compacts, and microporous polymer materials. The substrate will usually be planar in order to simplify fabrication and application of the membrane, but can take various geometric forms. Essentially the substrate and any other support have sufficient structural rigidity and response to the applied gas pressure to avoid bending or distortion, but also thereby limit the deformation and the stresses on the exposed, unsupported areas of the membrane coextensive with the pores. The pore density of the substrate is also sufficiently high to assure that the pressure drop across the film and substrate is principally across the film.

Further in accordance with the invention, filtration systems may be configured as gas separation cells, modules, or stacks. These may employ single, double or triple layers with one or two microporous substrates, forming composite membrane structures of different areal size. Cells may be advantageously arranged in multilayer modules which provide substantial increases in surface area with any compact configuration, using headers or manifolds to supply and collect feed gas, permeant and residual gas. Depending upon the efficiency of the separation that is desired, in relation to methane content and/or throughput, the modules can be arranged in parallel, or cascaded with progressively lower efficiency but greater methane percentage as further stages are added.

In a more specific example a stack of filter cells can be arranged within a housing, with paired, spaced apart membranes in each cell, feeding filtered methane from between the membranes to a common outlet. Input mixtures are transported in shear across the outer faces of the membranes, with output effluent from which methane has been extracted being directed to outlet ports. Inlet and outlet manifolds along the sides of a housing for the cells and the incorporation of an interior common passageway through the cells contribute to a compact, economic configuration. In addition, since the paired membranes in each cell both feed the common filtrate channel between the membranes, the pressure differential across the membranes is reduced and the required support is less.

### BRIEF DESCRIPTION OF THE DRAWINGS

A better understanding of the invention may be had by reference to the following description taken in conjunction with the accompanying drawings, in which:

FIG. 1 is a perspective enlarged and fragmentary view of a gas separation membrane on a microporous substrate and with an optional support mesh, in accordance with the invention;

FIG. 2 is a block diagram showing a number of steps utilized in processes for forming a gas separation membrane in accordance with the invention;

FIG. 3 is a perspective view of a roller system for applying a continuous ultrathin silicone film to a microporous substrate;

FIG. 4 is a side view of the roller system of FIG. 3;

FIG. 5 is a perspective view of a gas separation module employing membrane structures in accordance with the invention, the view being broken away to show further details thereof but not to scale;

FIG. 6 is a side sectional view of the module of FIG. 5 indicating approximate dimensions but also not to scale; and

FIG. 7 is a graph of permeability versus molar volume for rubbery versus a glassy polymer (polyetherimide).

### DETAILED DESCRIPTION OF THE INVENTION

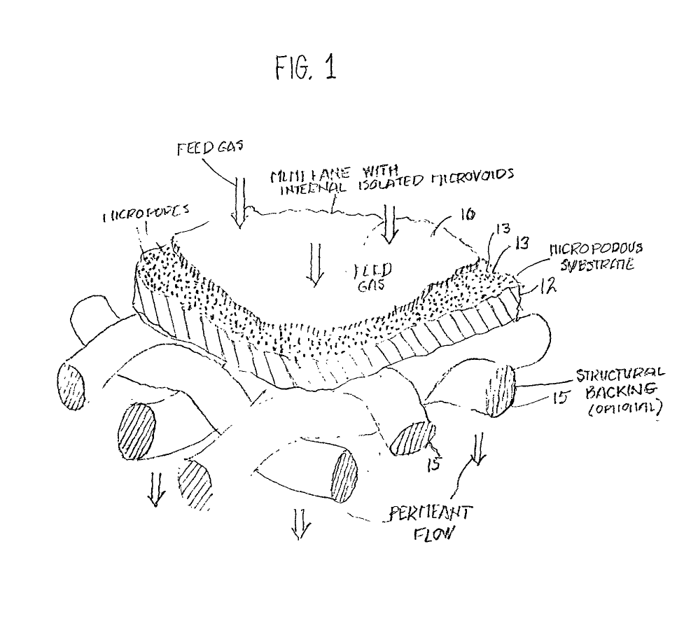

Referring now to FIG. 1, the basic subunit of the invention is an ultrathin membrane 10, of the order of five microns to one micron or less in thickness, deposited on a microporous substrate 12 having pores 13 of the order of five microns to as little as one micron in cross sectional dimension, regardless of the geometry of the pore 13. As shown, the membrane 10 is of a rubbery polymer material, preferably with random orientation of the interior polymeric strands, and while it may include microvoids, these are isolated from each other and not formed into continuous pathways which would constitute transferous pores in the membrane. For purposes of fabrication, it is convenient to deposit the membrane 10 on a microporous structure 12 of synthetic or polymeric material, with substantially uniform pore sizes and distribution, such as Millipore “Durapour”. Such material is flexible and relatively thin itself, so that it would tend to distort under gas pressure against the membrane. Structural rigidity can be enhanced later by annexing the composite membrane/microporous substrate to a load bearing structure, such as a stainless steel mesh 15.

These structures have all of the attributes desirable for the separation of gases within a mixture based upon differences in their solubility in silicone, the increase in efficiency due to the thinness of the membrane, and the ability to withstand high differential pressures. Given a microporous substrate 12 having at least 20% pore density, and preferably 75% or more, a high proportion of the area of the membrane 10 is effective as to selective separation. Because the areas of the membrane that are subject to deformation under pressure are those areas bridging the pores 13, and the pores are only of the order of five microns or less, rupture of the membrane and the creation of micropores does not occur. Furthermore, the formation of the membrane 10 is such that the membrane material does not seep or bend into the micropores 13, which would introduce variations in thickness that would effect filtration efficiency or might possibly introduce structural weak points.

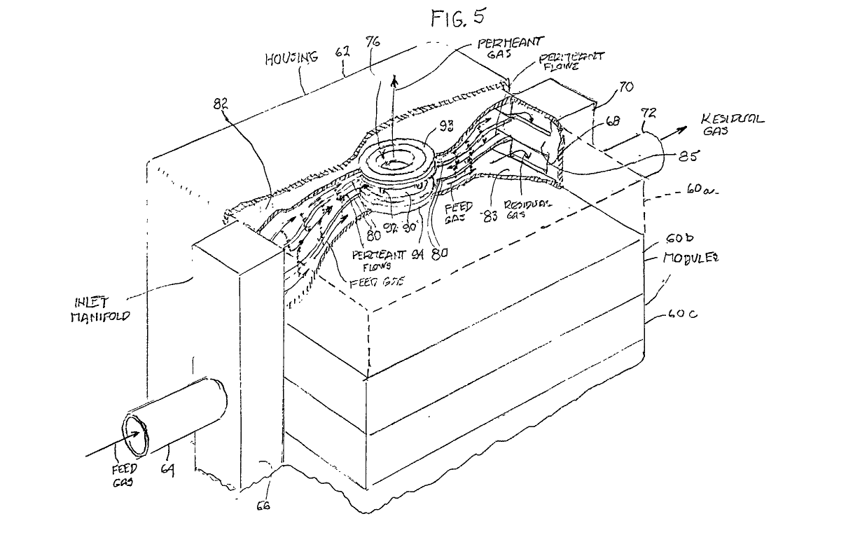

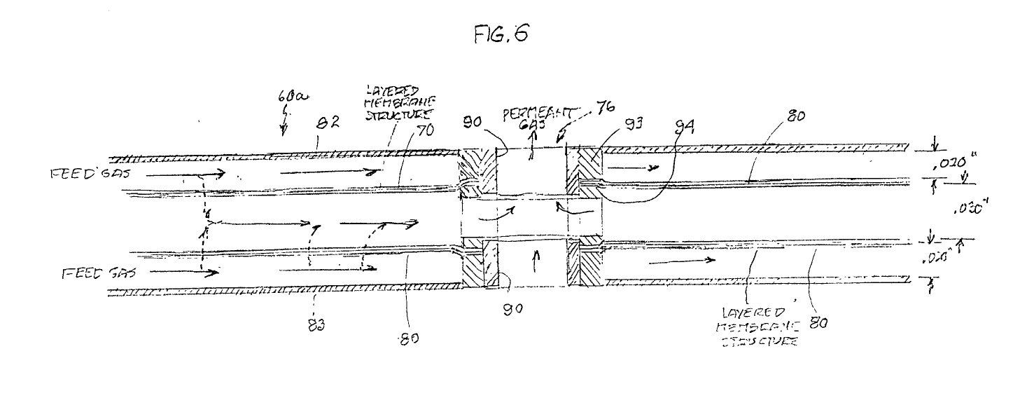

One desired objective of the ultrathin membrane 10 for gas separation applications involving natural gas is that it can withstand a pressure differential of about one hundred PSI or substantially more. This requirement is met by proper selection of the properties of the composite. With a non-loadbearing polymer as the substrate, when the composite film is laid on an open stainless steel mesh 15 or other porous structure, this provides both the loadbearing capability and, if desired, a high conductance flow path. This mesh can be on the order of 1/64 to 1/32 of an inch thick, in order to maintain a cell density high enough to provide substantially unimpeded convective flow. The Millipore substrate plus the mesh or other porous structure thus provides a flow path with a low-pressure drop for the permeant gas to transport to a central permeant gas collection area as detailed below in the filter cell structure of FIGS. 5 and 6. Alternatively the silicone membrane can be applied to thin porous ceramic or metal microporous substrates. The substrates, in addition to providing some loadbearing capability, should also provide unrestricted exit passageways for that fraction of the feed gases permeating through the membrane. It has been found that porous substrates having a pore diameter of about 1 micron or more and a pore density of 60% or more are able to carry away the permeant gas with a pressure drop much lower than that across the film. Some potential substrates can withstand higher gas temperatures than the Millipore “Durapour”, which has an upper temperature service limit of about 125° C.

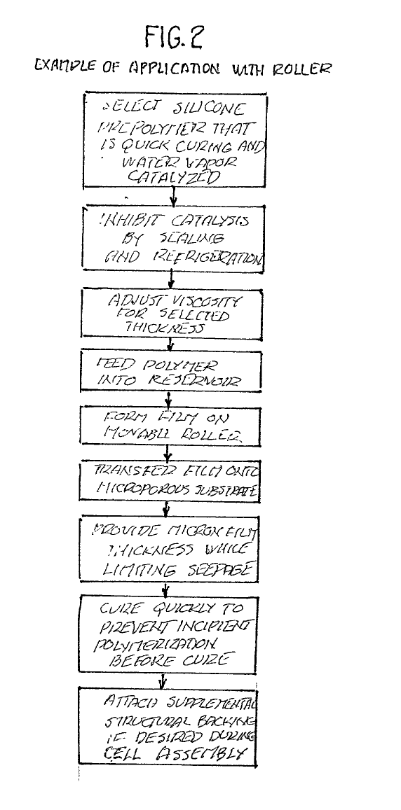

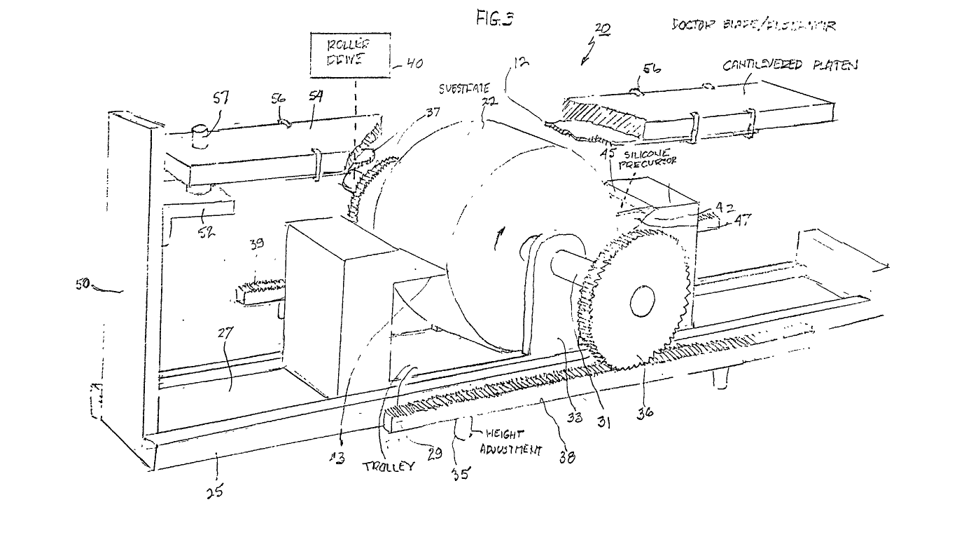

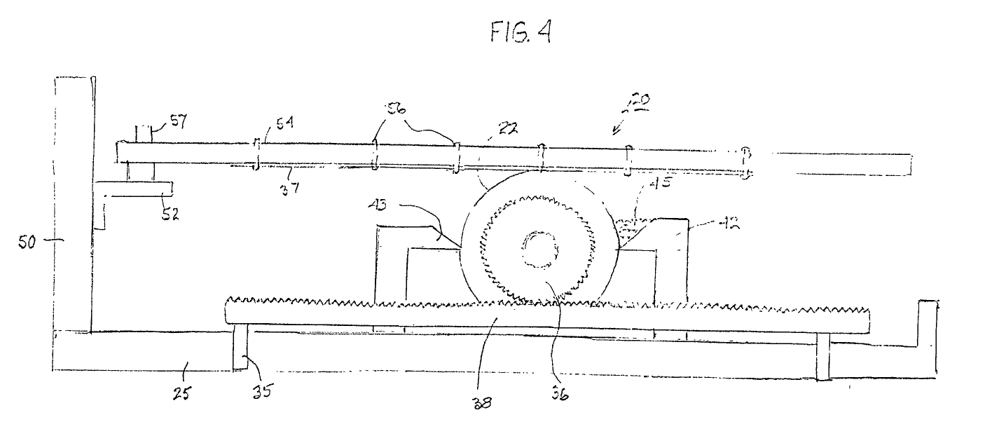

Referring now to FIG. 2, the principal steps in a method for making an ultrathin silicone membrane without micropores, in accordance with the invention, are depicted in block diagram form. An apparatus for forming the films on a substrate is shown in FIGS. 3 and 4 and described hereafter.

The silicon prepolymer is stored in airtight containers in a refrigerator until it is needed for membrane production. Then the polymer can be metered into a reservoir within a dry air environment held at about 40° F. until it is applied to the substrate. This step is taken to preclude incipient polymerization of the silicone prepolymer before it is applied to the substrate. Further the humidity of the air and the temperature in the film coating area can be controlled to improve the yield of silicone film and to provide a film within a given thickness tolerance.

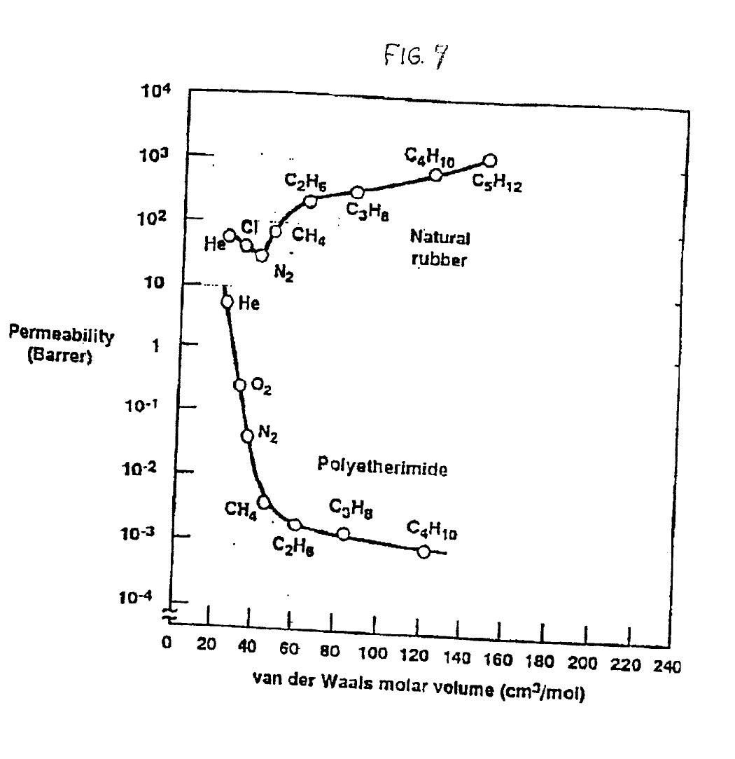

This precursor material after being held refrigerated and sealed from moisture at 40° F. is then applied rapidly to a microporous substrate. The microporous material, preferably Millipore “Durapour”, is a polyvinylidene fluoride filtration material having a pore density of 70% and pore diameters of as little as 1 micron. The films are applied to this substrate using an ink roller type action extended over a selected width and length. SEM images of the film-substrate cross-section show, in one example, a 4-micron silicone film on a 120-micron thick Millipore substrate, with no indication of seepage of the silicone film into the pores in the substrate. To determine the gas permeation properties of this film a test apparatus was constructed to measure such properties with a feed gas mixture of 75% methane and 25% nitrogen. The total gas effluent flow was measured with a flow meter and the speciation determined with samples of the permeant gas fed off-line to a gas chromatograph. The results of these measurements indicated a permeability of 25 barrers of nitrogen and 80 barrers for methane. (1 barrer is equal to 1×10⁻⁹ cm³−cm/cm²/cm² of Hg.) These are the historic values for “bulk silicone” as shown in FIG. 7 and Table 1 hereafter and hence indicate the ability of the present process to produce ultrathin film with “bulk silicone” permeability properties, and ultrathin silicone films without a “pore effect”. The above process can produce thinner films to chosen specifications by control of rate, temperature or viscosity. Lowering the viscosity of the silicone precursor material can be readily done by the addition of more naphtha solvent to the precursor material. In fact films about 0.25 micron thick were later produced by such methods having the bulk permeability properties indicated above.

determination of actual film thickness has to be done indirectly because the membrane is too thin and too adherent to the microporous substrate for direct measurement, at least by conventional techniques. However, permeation rates provide some guidance and basis for comparison, since there is published data for permeation of other gases through given thicknesses of silicone under known pressures. By adjusting known permeation rates for other gases to silicone, and measuring the permeation rates under different pressures, the thickness of the membrane is calculated to be extremely (and beneficially) low—on average in the range of 0.040 to 0.0060. Consequently significant breakthroughs in permeation rates and selectivity as well as cost can be foreseen.

The permeability of a membrane of such thinness is greatly enhanced, and further increases disproportionately with pressure. With nitrogen, for example, the permeability increases between 2× and 3× when pressure is increased from 30 to 50 psi. The structural properties of the silicone composite membrane are more than adequate under these and higher differential pressures. In practical applications properly made composite membranes have not failed under the pressure loadings expected to be used.

The selectivity of the silicone composite membrane has been determined by gas chromatograph results, as compared to prior published data on silicone composite membranes of the prior art, although inferior substrate structures were used in that prior art. It was calculated, by normalizing area data and equalizing time and pressure factors, that an initial methane constituency of 75% was upgraded to only 85.6% by the prior art membrane, while a level of 91.3% was reached by using silicone composite membranes in accordance with the present invention. This means a corresponding higher methane selectivity, with consequent benefits in cost and performance.

An apparatus 20 based on a roller system that is useful in forming the ultrathin membrane 10 on a microporous substrate 12 is shown in FIGS. 3 and 4. The width of the roller system is chosen so that the silicone film 10 can be applied to the substrate 12 in one pass. That is, it is as wide or slightly wider than the film width required for a gas separation cell. As shown in FIGS. 3 and 4 the substrate 12 rests lightly on the top of the roller 22 in the application process. This loading condition precludes applying an application pressure which might otherwise press the silicone membrane 10 into the pores 13 of the substrate 12, thus creating an irregular or thick silicone film. When attached to the substrate 12, the silicone will be substantially free of solvents in one minute, and will be nearly cured to a gel but still soft film in less than about 5 minutes. The organic clusters that form the side chains of the silicone molecular backbones preferentially tend to bond to other such clusters on adjoining silicone molecular backbones pulling the silicone into a homogeneous uniform film. The polymerization process will create zones of free volume but due to the time of the curing process, combined with high viscosity, will not linkup and grow into the pore structures that destroy the selective gas permeation properties of the film. Scanning electron microscope images of the films reveal that it is “amorphous, homogeneous and nonporous”.

The following is the description of an exemplary coating apparatus 20 (FIGS. 3 and 4) for the deposition of micron or sub-micron thick silicone films on a Millipore or other porous film substrate material having approximately micron sized connected pore structures. The present design uses the roller action and completes the application of the film in a single pass. The circumference of the roller 22 is chosen to be greater than the length of the substrate surface to which the silicone is being applied and the width of the roller is chosen to be somewhat greater than the width of the substrate surface to which the silicone is being applied. The dimensions of a Millipore substrate selected for the gas separation cell examples here are 3.5 in. width by 7 in. length. Thus the roller diameter as shown in FIGS. 3 and 4 is 2½″ in diameter (7.85″ circumference) and 3 ¾″ in width. It has been demonstrated that if the weight of the roller 22 bears vertically on the substrate surface then the weight tends to press the silicone precursor material into the substrate material. Under this condition the resulting silicone films are also undesirably thick and effectively non-uniform.

Such potential problems are resolved by the film deposition system of FIGS. 3 and 4. A base frame 25 having a longitudinal raceway 27 forms a horizontal straight path for a movable trolley 29 carrying the roller 22 on a shaft 31 transverse to the raceway 27. The shaft 31 is mounted to rotate within upstanding supports 33, in the central region of the trolley 29, and is coupled to spur gears 36, 37 at or adjacent each end. The spur gears 36, 37 engage longitudinal rack gears 38, 39 parallel to the raceway 27 and on each side of the base frame 25. The rack gears 38,39 are mounted on height adjustable supports 35 for raising or lowering the roller 22 relative to an overlying substrate 12 so as to control the roller 22 relation to the substrate 12. The mounts for the roller 22, trolley 29, or the substrate support may also or alternatively be adjustable for this purpose. The shaft 31 is rotated by a roller drive 40 which may be a manual crank, electric motor or a mechanical rotator.

A pair of oppositely angled doctor blades 42, 43 are mounted on the trolley to skin the opposite sides of the circumference of the roller 22 as it rotates, thus controlling the thickness of material on the roller 22. A first doctor blade 42 is shaped and angled to form a reservoir 45 for silicone prepolymer, the prepolymer being confined by side panels 47, only one of which is visible. Prepolymer in the reservoir is deposited on the roller 22 surface during its rotation. Material on the roller 22 then moves to the second doctor blade 43, the edge of which is parallel to and spaced from the roller surface by a small predetermined gap, excusing excess material just before contact with the overlying substrate 12, assuring uniform film thickness.

A side wall 50 at the end of the base frame 25 extends vertically to above the roller 22, and includes a support bracket 52 angled toward the roller 22. A light weight paddle or platen 54 extending parallel to the raceway 27 and above the roller 22 is supported by a single pin 57 so that the substrate 12, which tends to drape under gravity, is uniformly pressed between the paddle 54 and roller 22 but without the weight of the paddle 54.

The substrate 22 material is clamped to the underside of the light weight paddle 54 by removable means, such as clamps 56 or spring loaded hinges (not shown) and the roller 22 is translated underneath the substrate 42 by the spur gears 36, 37 attached to both sides of the roller 22, which mesh with the rack gears 38, 39 on each side of the base frame 25. The roller/trolley assembly is thus rapidly translated across the substrate 12 and the interplay of substrate 12 surface adhesive forces, silicone film viscosity, and gravity controls the resulting silicone film 10 thickness. Depending on the viscosity and other process variables of a particular silicone, films in the ¼ to 5-micron thickness range can be laid down reproducibly. Silicone films produced by this method have evidenced excellent yield in terms of uniformity of their properties and quality.

Observations by the applicant of ultrathin silicone films applied to a “Teflon” substrate showed polymer chains aligned in the direction of the roller action. “Teflon” was chosen because it does not interact with or structurally influence the film formation. This suggested that incipient polymerization was already occurring before the application of the silicon/solvent precursor material to the “Teflon” substrate. More generally, using the analogue of general two-phase growth, the two phases tend to separate spatially unless the process proceeds so rapidly that there is insufficient time or rate for the phase separation to occur. In the present discussion the two phases are the polymer and the free volume. The separation of the two phases is promoted by polymer nucleation sites, e.g. incipient polymerization; slow monomer to polymer reaction; low viscosity and low temperature.

FIGS. 5 and 6 depict an example of a gas membrane filtration unit in accordance with the invention employing a modular construction. Although membrane filtration systems can be designed in many forms and sizes, dependent on the application and flow requirements, they will often be configured using modular or cellular approaches, so they can be fabricated more economically and then arranged in parallel, cascade or other combinations. In this example the unit is assembled from parallel modules 60a, 60b, 60c, etc. (FIG. 5 only), stacked within a common housing 62. In order to depict the overall arrangement more clearly, the scale of FIG. 5 has been greatly exaggerated as to the spacings between the different layers in a module. The view of FIG. 6 is also not to scale, but relative spacings between layers have been indicated to demonstrate the arrangement of filter elements in each module.

The modules 60a, b, c, etc. are in this example stacked vertically (the term being used as a frame of reference only) within the housing 62, and each is supplied feed gas (the nitrogen-contaminated methane gas) via an inlet 64, and a common inlet manifold 66 at one side of the housing 62. Individual inlet ports (not shown in FIG. 5) are provided in the module (e.g. 60a) in line with each channel, similarly to outlet ports 68, that lead to a common outlet manifold 70 which communicates with the outlet conduit 72 to carry off residual gas of higher nitrogen content. At the approximate center of the top wall of the housing 62 is an exit port 76 for permeant gas. The placement and geometry of these ports, and the directions of flow, can be varied to meet different situations, but the example shown provides a manufacturable module that is readily assembled.

The layered membrane structures 80 in accordance with the invention that are incorporated in the modules 60a, b, c, etc., can be in one of a number of different combinations, such as a single silicone film supported by a microporous substrate such as Millipore “Durapour” backed by a porous stainless steel mesh. Alternatively, a single mesh layer may have substrate and membrane layers on each side, or for small lower pressure differential units the mesh support may be supplanted by another type of convective reinforcement or no reinforcement at all. In the present example, assuming the 3.5″ wide strips fabricated in accordance with the example of FIGS. 3 and 4, and an operating pressure of 100 psi or more a structural reinforcement is highly desirable. The modules, such as module 60a, have top and bottom walls 82, 83 respectively, and opposite side walls 85 which include the entry and exit ports respectively. The outer peripheries of the layered membrane structures 80 are firmly and sealingly joined to the side walls 85 by conventional means, such as sealant adhesives, beaded or dipped edges that are heat bonded to the walls 85 or by added sealant, so that no convective paths exist. At the central region aligned with the effluent exit port 76, on the other hand, flow paths as well as edge sealing must both be provided. Referencing both FIGS. 5 and 6, an arrangement of rings concentric with the central axis of the channel leading to the exit port 76 is advantageous for this purpose. The exterior of the central vertical channel is defined by the inner diameter of rings 90 in a series, the rings being vertically separated by spacer rods 92 to form a unitary central structure. The peripheries of the layered membrane structures 80 are tightly sealed between the two parts, split rings 93, 94 that are joined to the inner rings 90. Again, conventional techniques can be employed to assure the joinders are leakage free.

Within each module, such as 60a, therefore, feed gases move under pressure in the feed gas channels, with permeant passing through the membrane structures and into the permeant channels between the membrane structures 70, 80. with both permanent flows combined, the pressure differential across the membrane structures is reduced. After passing over the available area of membrane, the residual gases have had permeant extracted to a level dependent on area, efficiency, pressure and temperature, and are conducted out the outlet port. Recirculation may be used, either by mixing with input feed gas or by passing into a different module of like or a different configuration.

The geometry of a cell or module can be largely symmetrical or asymmetrical, as by using a long path length of membrane/substrate/support structure in comparison to length. Means may be incorporated to assure thorough mixing of the feed gas, as in the form of porous spacers which do not inhibit flow substantially or internal elements to induce turbulence. Channel dimensions can be varied as desirable, to improve extraction of remaining methane after sufficient permeant has been filtered through to cause a significant increase in nitrogen percentage.

There are obviously other mixed gas systems with which the capability of rubbery polymers for separating gases of closely spaced molecular weights can be of benefit. Further, the present structures and methods can also be used to advantage in combination with other fractionation and filtration techniques. The energy demands are low and given proper maintenance there is minimal degradation of performance with time. The channels can also be varied in accordance with usage requirements and the particular multilayer permeable barrier that is used. For example, if a structural mesh is employed the channel on the permeant side can be shallow, because permeant can flow laterally across the mesh with low pressure loss. The stainless steel mesh or another structural support can thus itself define a permeant channel where membrane/substrate layers are used on both sides.

Broader data as to silicone film permeation rates has been provided by others in the field, thus evidencing that there are numerous combinations of gas separation options. The Table below was taken from the book “Polymeric Gas Separation Membranes” by Paul and Yampol'skii, p. 362.

The permeation rates of several gases and liquid vapors through polydimethylsiloxane elastomer are shown below in Table 1.

(The numbers given represent cubic centimeters times 10⁻⁹of gas at normal temperature and pressure diffusing through one centimeter per second, per square centimeter, per centimeter of mercury pressure difference.)

TABLE 1

| | | | | | |
|---|---|---|---|---|---|
| N₂ | 25 | CH₆ | 80 | Acetone | 490 |
| He | 30 | C₂H₄ | 115 | Toluene | 750 |
| CO | 30 | C₂H₆ | 210 | Benzene | 900 |
| O₂ | 50 | C₂H₂ | 2200 | HCHO | 925 |
| Ar | 50 | C₂H₈ | 340 | CH₃OH | 1160 |
| NO | 50 | C₄H₁₁ | 750 | COCL₂ | 1250 |
| H₂ | 55 | C₅H₁₂ | 1670 | Pyridine | 1595 |
| Xe | 171 | C₆H₁₄ | 785 | Phenol | 1750 |
| CO₂ | 270 | C₈H₁₈ | 715 | H₂O | 3000 |
| N₂O | 365 | C₁₀H₂₂ | 360 | CCL₄ | 5835 |
| MH₃ | 500 | Freon 115 | 51 | | |
| NO₄ | 635 | Freon 12 | 107 | | |
| M₂S | 840 | Freon 114 | 211 | | |
| SO₂ | 1250 | Freon 22 | 382 | | |
| CS₂ | 7500 | Freon 11 | 1790 | | |

FIG. 7 is a graph which compares the permeability of rubbery based materials versus polyetherimides as a function of penetrant critical volume, which is a convenient measure of penetrant molecular size.

In general for a given gas specie the permeation process through such a film or membrane is given by Fick's law, namely

$${J}_{x} = \frac{{S}_{x} \times A}{1} \times ( {P}_{x}^{1} - {P}_{x}^{2} )$$

Where x denotes the gas specie, Jₓ is the net flux of specie x gas through the film, Sₓ is the permeability, P¹ₓ−P²ₓ is the pressure difference between the two sides of the film for species x, A is the area of the film and t is its thickness. The thinner the film, therefore, the less the upstream pressure and/or the film area required for a given gas separation rate. To prepare ultrathin films, i.e. films of microns in thickness, of silicone material, however, the historic problem has been the films are crystalline and porous, in contrast to thicker silicone films, i.e., 10s of microns thickness or greater which are rubbery and amorphous. The porosity results in a large, non-specie selective gas flow through the film material and has heretofore defeated the used of ultrathin silicone gas separation membranes. All polymers are inherently “microporous”, that is any unit of polymer volume consists of “occupied volume” and “free volume”. Occupied volume is the space occupied by polymer molecules while free volume is the space not occupied by polymer molecules. The free volume may consist of void space among the polymer molecules or void regions in which there are no polymer molecules. Depending on the cure process voids may grow from agglomeration of free volume and further link up forming long micropores. In past attempts to produce ultrathin films of the silicone polymers such micropores developed and penetrated through the membrane structure. These pores are readily apparent in scanning electron microscope images of such silicone films. Such interlinked pores create gas flow paths of sufficient magnitude that the flow through such channels predominates. This flow is viscous and thus leads to a situation in which no separation of gas species takes place.

The invention includes not only the forms and expedients described herein but variations and alternatives of the concepts involved that are within the scope of the appended claims.

I claim:

1. A membrane layer structure for separation of gases of closely adjacent molecular sizes comprising:
a microporous substrate having a pore density in excess of 20% of its area and pore sizes of the order of one micron; and
an ultrathin membrane of permselective material disposed on the substrate and bridging the micropores of the substrate, the membrane being of about five microns or less thick in the areas bridging the pores.

2. A structure as set forth in claim 1 above, wherein the membrane includes unlinked microvoids of submicron dimension.

3. A structure as set forth in claim 1 above, wherein the substrate has a pore density of 60% or more and the permselective membrane is a silicone material.

4. A structure as set forth in claim 1 above, wherein the structure in addition includes a pressure-resisting mesh engaging the substrate, and wherein the mesh is metal and of the order of 1/64 to 1/32 thick

5. A structure as set forth in claim 4 above, wherein in addition a separate substrate and a separate membrane are engaged on each side of the mesh, and wherein the mesh is of stainless steel.

6. A structure as set forth in claim 1 above, wherein the substrate is of polyvinylidene and the membrane is of silicone.

7. A membrane layer structure for separation of nitrogen from methane gas, comprising the combination of:
a first layer of silicone material of about five microns or less in thickness, the first layer containing internal microvoids but being substantially free of free convective paths therethrough, and
a second layer of supportive material, adjacent and contiguous to the first layer, the second layer being of the order of five microns in thickness and having distributed convective micropores with a pore area density in the range of 20% to 75% or more of the area of the second layer, and a matrix of interconnecting pathways having sufficient tensile strength to support the first layer against a pressure of at least 10 psi on the first layer side of the structure.

8. A structure as set forth in claim 7 above, wherein the first layer has substantially like thickness in the microareas bridging the micropores as the areas contiguous with the pathways of the second layer, and wherein the pore areas are of the order of 75% or more of the second layer areas, wherein the second layer provides high conductance flow paths for permeant methane filtered by the first layer.

9. A structure as set forth in claim 8 above, wherein the first layer thickness is in the range from about 0.040 microns to about 0.10 microns.

10. The method of making a permselective membrane structure with a layer of porous substrate and a thin layer of membrane comprising the steps of:
supporting the substrate on a first side;
rolling a solvent containing, air curable, silicone material onto the substrate on the opposite side from the first side, and gelling the substrate within 5 minutes of application.

11. A method as set forth in claim 10 above, wherein silicone material has a viscosity in the range of 500-5000 centipoise, and further including the steps of refrigerating and sealing the silicone material against air until application to block initiation of polymerization, and controlling the temperature and humidity until gelling has at least commenced.

12. A method as set forth in claim 11 above, wherein the temperature is held at about 40% F. until applied to preclude incipient polymerization and sealed from water vapor until catalyzed.

13. A method as set forth in claim 12 above, wherein the silicone material is rolled on the substrate at a rate in relation to the viscosity to deposit a layer of less than about 5 microns in thickness.

14. A method as set forth in claim 13 above, wherein the permselective membrane structure is intended to separate nitrogen from methane in native petroleum gases, and wherein the method further includes the step of rolling the silicone material to a thickness of less than about one micron.

15. The method of forming an ultrathin membrane of permselective silicone for gas filtration purposes comprising the steps of:
maintaining an air curable silicone material in pre-polymerized form until processing begins;
flowing the prepolymer into a reservoir under conditions inhibiting incipient polymerization;
rapidly forming a mechanical layer of selected small thickness during initiation of air curing;
transferring the mechanical layer with minimal pressure onto a support substrate in distributed fashion;
curing the silicone material to gel state within 5 minutes or less on the substrate, and
fully curing the silicone material on the substrate.

16. The method as set forth in claim 15 above, wherein the incipient polymerization is inhibited by maintaining the silicone in dry air at about 40° F., and wherein the silicone is catalyzed by water vapor in the air.

17. The method as set forth in claim 16 above, wherein the steps of rapidly forming and transferring the material comprises forming a reservoir of the material and rolling the surface of a member through the reservoir and against the support substrate surface with pressure just sufficient to cause a degree of adherence of the material to the substrate.

18. The method as set forth in claim 17 above, wherein the step of transferring comprises supporting the substrate above the membrane and rolling layer onto the underside of the substrate.

19. The method as set forth in claim 18 above, further comprising the steps of varying the conditions in forming the layer of silicone material to adjust the deposited thickness, and also excising material in excess of a predetermined thickness from the surface of the member after rolling through the reservoir.

20. A machine for forming a sheet of layered material for selective filtration of gases comprising:
a bed for receiving a substrate sheet of microporous material, along a longitudinal axis;
a roller having a low friction surface movable along the bed along the longitudinal axis, the roller engaging the underside of the substrate on the bed with a limited pressure;
a reservoir for curable material disposed along one side of the roller for distributing material on the roller across its lateral dimension;
at least one doctor blade spaced from roller to excise excess thickness of material distributed on the roller; and
a drive for advancing the roller along the longitudinal axis, with the curable material on its surface in contact with the substrate.

21. A machine in accordance with claim 20 above, for forming filtration sheets of selected length and width dimension, wherein the roller has a circumferential dimension greater than the length of the sheet and a surface length along its longitudinal axis that is at least as great as the width of the sheet.

22. A machine in accordance with claim 21 above, wherein the bed comprises an upper support surface above and approximately tangential to the upper side of the roller, holders for retaining the microporous material on the underside of the support surface, and wherein the reservoir includes a blade element having an exit edge spaced from the roller to provide an initial thickness of material distribution on the roller.

23. A filter system for separating methane gas from an intermixed nitrogen contaminant, comprising:
a housing structure having a central passageway disposed along a central axis between a first outer wall and a second outer wall a plurality of inlet ports disposed at the first outer wall substantially parallel to the central axis and with substantially regular spacings in a first direction along the wall, and a plurality of outlet ports disposed at the second outer wall on the opposite side of the central axis from the first wall, and at substantially regular spacings in the first direction,
and a plurality of filter cells, each disposed within the housing in a separate plane transverse to the first axis, and positioned successively along the first axis, each filter cell having at least one planar filtration membrane structure and an input port on a first side of the membrane for receiving a methane-nitrogen gas mixture via a different inlet port of the housing; each filter cell also including a central output port communicating gases from the second side of the membrane into the central passageway for emitting predominately filtered methane as output, and each filter cell also including a second output port in communication with a different outlet port in the second wall for emitting nitrogen enhanced effluent from which methane has been extracted.

24. A filter cell as set forth in claim 23 above, wherein the filter cells each have a pair of spaced apart, separated substrate/membrane laminates and the cells are configured to receive nitrogen containing methane into the interior between the laminates and fee filtered methane out the outer surfaces of the laminates relative to the interior into communication with the central passageway with residual nitrogen effluent going to the outlet ports.

25. A filter cell for effecting a degree of separation of a contaminating gas, such as nitrogen, from the principally methane gas product derived from a petroleum well, comprising:
a pair of substantially parallel and spaced apart membrane-based filter elements, each comprising a permselective membrane of less than about 5 microns in thickness and a microporous support layer contiguous and in contact therewith, the support layer having a pore density from about 20% to about 75%, the support layer sides being in facing relation and separated by a permeant channel;
a feed system for providing the gas product under pressure to the membrane sides of both filter elements from one side thereof to flow the gas product across the membrane surfaces;
a permeant gas outlet in communication with the permeant channel, and
a gas product outlet spaced apart form the feed system side for outputting gas product having a higher proportion of nitrogen than the original gas product input.
